(19) United States
(12) Patent Application Publication
(10) Pub. No.: US 2025/0323460 A1
(43) Pub. Date: Oct. 16, 2025

(54) ELECTRICAL CONNECTOR WITH IMPROVED SHIELDING EFFECT

(71) Applicant: DONGGUAN LUXSHARE TECHNOLOGIES CO., LTD, Dongguan City (CN)

(72) Inventors: Bin HUANG, Dongguan City (CN); Chenhui ZENG, Dongguan City (CN); Kunlin YAO, Dongguan City (CN); Qiongnan CHEN, Dongguan City (CN); Hongji CHEN, Dongguan City (CN)

(73) Assignee: DONGGUAN LUXSHARE TECHNOLOGIES CO., LTD, Dongguan City (CN)

(21) Appl. No.: 18/778,071

(22) Filed: Jul. 19, 2024

(30) Foreign Application Priority Data
Apr. 16, 2024 (CN) 202410459011.X

(51) Int. Cl. H01R 13/6581; H01R 12/79

(52) U.S. Cl. CPC H01R 13/6581; H01R 12/79

(57) ABSTRACT

An electrical connector includes a first module and a second module. The first module includes a first conductive housing, a first terminal module and a number of first cables. The second module includes a second conductive housing, a second terminal module and a number of second cables. The first conductive housing of the first module and the second conductive housing of the second module are separately arranged and fixed together to jointly form a receiving slot. The receiving slot is configured to at least partially receive a mating module along a first direction. The first module and the second module are the same module with different installation angles.

### CROSS-REFERENCE TO RELATED APPLICATION

This patent application claims priority of a Chinese Patent Application No. 202410459011.X, filed on Apr. 16, 2024 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

An electrical connector in the related art includes an insulating body, a plurality of conductive terminals mounted to the insulating body, and a metal shell installed on the insulating body. The plurality of conductive terminals include a plurality of signal terminals. However, as the requirements for signal transmission quality of electrical connectors continue to increase, there is still room for improvement in electrical connectors in related technologies.

### SUMMARY

An object of the present disclosure is to provide an electrical connector which is beneficial to high-speed transmission, has good shielding effect, and is beneficial to cost saving.

In order to achieve the above object, the present disclosure adopts the following technical solution: an electrical connector, including: a first module including: a first conductive housing; a first terminal module, the first terminal module being at least partially mounted to the first conductive housing; the first terminal module including a plurality of first conductive terminals; each first conductive terminal including a first contact arm and a first tail portion; the first contact arm including a first contact portion configured to be in contact with a mating module to achieve electrical connection; and a plurality of first cables, the plurality of first cables being electrically connected to the first tail portions of the first conductive terminals of the first terminal module; a second module including: a second conductive housing; a second terminal module, the second terminal module being at least partially mounted to the second conductive housing; the second terminal module including a plurality of second conductive terminals; each second conductive terminal including a second contact arm and a second tail portion; the second contact arm including a second contact portion configured to be in contact with the mating module to achieve electrical connection; and a plurality of second cables, the plurality of second cables being electrically connected to the second tail portions of the second conductive terminals of the second terminal module; wherein the first conductive housing of the first module and the second conductive housing of the second module are separately arranged and fixed together to jointly form a receiving slot; the receiving slot is configured to at least partially receive the mating module along a first direction; the first contact portions of the first conductive terminals and the second contact portions of the second conductive terminals protrude into the receiving slot; the first module and the second module are a same module with different installation angles.

In order to achieve the above object, the present disclosure adopts the following technical solution: an electrical connector, including: a first module including: a first conductive housing; a plurality of first terminal modules, the first terminal modules being at least partially mounted to the first conductive housing; each first terminal module including a plurality of first conductive terminals; each first conductive terminal including a first contact arm; the first contact arm including a first contact portion configured to be electrically connected with a mating module; and a plurality of first cables, the plurality of first cables being electrically connected to the first conductive terminals of the first terminal modules; a second module including: a second conductive housing; a plurality of second terminal modules, the second terminal modules being at least partially mounted to the second conductive housing; each second terminal module including a plurality of second conductive terminals; each second conductive terminal including a second contact arm; the second contact arm including a second contact portion configured to be electrically connected with the mating module; and a plurality of second cables, the plurality of second cables being electrically connected to the second conductive terminals of the second terminal modules; wherein the first conductive housing of the first module and the second conductive housing of the second module are separately arranged and fixed together to jointly form a receiving slot; the receiving slot is configured to at least partially receive the mating module along a first direction; the first module and the second module are shared modules with different installation angles.

Compared with the prior art, in the present disclosure, the first conductive terminal is electrically connected to the first cable, and the second conductive terminal is electrically connected to the second cable, which is beneficial to achieve high-speed signal transmission through the first cable and the second cable, thereby being suitable to meet higher-speed signal transmission requirements. Besides, by providing the first conductive housing and the second conductive housing, the shielding effect on the first conductive terminals and the second conductive terminals can be improved, thereby improving the quality of signal transmission. Furthermore, by providing the first module and the second module to be the same module with different installation angles, the number of molds can be reduced and parts can be shared as much as possible, thereby saving costs.

### BRIEF DESCRIPTION OF DRAWINGS

FIG. 1 is a perspective schematic view of a connector assembly in accordance with an embodiment of the present disclosure;

FIG. 2 is a perspective view of FIG. 1 from another angle;

FIG. 3 is a partially exploded perspective view of FIG. 1, in which a first module and a second module are separated from each other;

FIG. 4 is a partially exploded perspective view of FIG. 3 from another angle;

FIG. 5 is a partial enlarged view of a circled portion B in FIG. 3;

FIG. 6 is a partial enlarged view of a circled portion C in FIG. 4;

FIG. 7 is a top view of the first module and the second module when they are separated from each other;

FIG. 8 is a bottom view of FIG. 7;

FIG. 9 is a front view of an electrical connector in FIG. 1;

FIG. 10 is a further partially exploded perspective view of FIG. 3;

FIG. 11 is a further partially exploded perspective view of FIG. 10;

FIG. 12 is a partially exploded perspective view of the first module;

FIG. 13 is a partially exploded perspective view of FIG. 12 from another angle;

FIG. 14 is a left view of FIG. 12;

FIG. 15 is a further partial perspective exploded view of the first module;

FIG. 16 is a partially exploded perspective view of the second module;

FIG. 17 is a partially exploded perspective view of FIG. 16 from another angle;

FIG. 18 is a left view of FIG. 16;

FIG. 19 is a further partial perspective exploded view of the second module;

FIG. 20 is a partial enlarged view of a circled portion E in FIG. 15;

FIG. 21 is a partial enlarged view of a circled portion G in FIG. 19;

FIG. 22 is a partial enlarged view of a frame portion D in FIG. 15;

FIG. 23 is a partial enlarged view of a frame portion F in FIG. 19; and

FIG. 24 is a schematic cross-sectional view taken along line H-H in FIG. 9.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

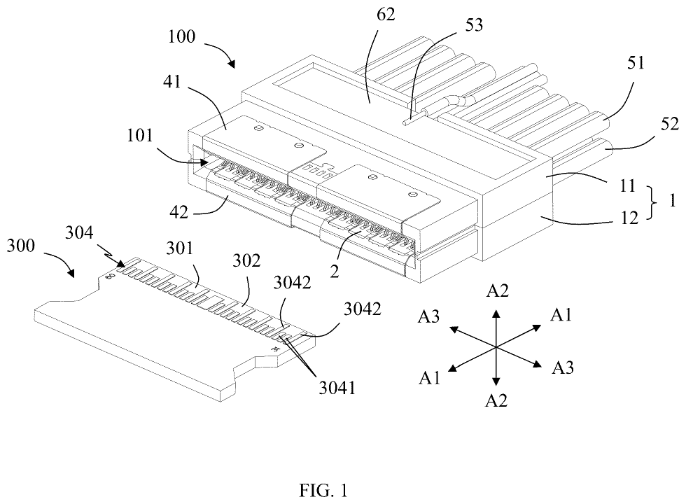

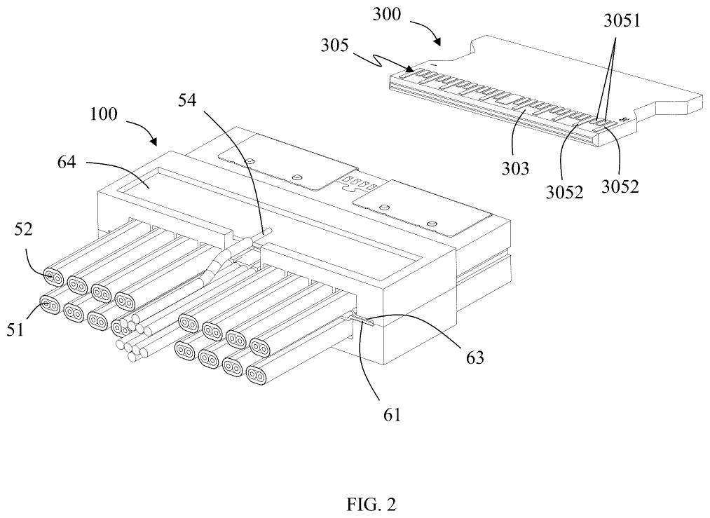

Referring to FIG. 1 and FIG. 2, the present disclosure discloses a connector assembly including an electrical connector 100 and a mating module 300 configured to be at least partially inserted into the electrical connector 100. In the illustrated embodiment of the present disclosure, the electrical connector 100 is an OSFP (Octal Small Form-factor Pluggable) receptacle connector. More specifically, in the illustrated embodiment of the present disclosure, the electrical connector 100 is a receptacle cable connector. Correspondingly, the mating module 300 is an OSFP plug connector. Of course, it is understandable to those skilled in the art that the electrical connector 100 can also be an SFP (Small Form-factor Pluggable) receptacle connector, a QSFP (Quad Small Form-factor Pluggable) receptacle connector, a QSFP-DD (Quad Small Form-factor Pluggable-Double Density) receptacle connector, an SFP-DD (Small Form-factor Pluggable-Double Density) receptacle connector or a DSFP (Dual Chanel Small Form-factor Pluggable) receptacle connector, etc. Correspondingly, the mating module 300 is an SFP plug connector, a QSFP plug connector, a QSFP-DD plug connector, an SFP-DD plug connector or a DSFP plug connector, etc. It is understandable to those skilled in the art that the basic structure of the above types of the electrical connectors is regulated by corresponding association standards, and will not be described in detail here.

Referring to FIG. 1, in the illustrated embodiment of the present disclosure, the electrical connector 100 defines a receiving slot 101 for at least partially receiving the mating module 300. To simplify the description of the specific embodiments of the present disclosure, an insertion and extraction direction of the mating module 300 and the electrical connector 100 is a first direction A1-A1 (for example, a front-rear direction); a thickness direction of the receiving slot 101 is a second direction A2-A2 (for example, a top-bottom direction); a width direction of the receiving slot 101 is a third direction A3-A3 (for example, a left-right direction). Each two of the first direction A1-A1, the second direction A2-A2 and the third direction A3-A3 are perpendicular to each other.

As shown in FIG. 1 and FIG. 2, the mating module 300 includes a tongue plate 301. The tongue plate 301 includes a tongue plate upper surface 302, a tongue plate lower surface 303, a plurality of first contact pads 304 exposed to the tongue plate upper surface 302, and a plurality of second contact pads 305 exposed to the tongue plate lower surface 303. The plurality of first contact pads 304 are disposed at intervals along the third direction A3-A3. The plurality of second contact pads 305 are disposed at intervals along the third direction A3-A3.

Specifically, in the illustrated embodiment of the present disclosure, the plurality of first contact pads 304 include a plurality of first signal contact pads 3041 and a plurality of first ground contact pads 3042. The plurality of first signal contact pads 3041 are divided into a plurality of groups, in which each group includes two first signal contact pads 3041 adjacently arranged along the third direction A3-A3. Each group of first signal contact pads 3041 is associated with two first ground contact pads 3042 which are located on two sides thereof respectively, so as to improve shielding and improve signal transmission quality. In the illustrated embodiment of the present disclosure, each group of first signal contact pads 3041 forms a differential pair to increase the speed of signal transmission. In the illustrated embodiment of the present disclosure, a length of each first ground contact pad 3042 along the first direction A1-A1 is greater than a length of each first signal contact pad 3041 along the first direction A1-A1, so as to better improve the shielding and improve the signal transmission quality.

Similarly, in the illustrated embodiment of the present disclosure, the plurality of second contact pads 305 include a plurality of second signal contact pads 3051 and a plurality of second ground contact pads 3052. The plurality of second signal contact pads 3051 are divided into a plurality of groups, in which each group includes two second signal contact pads 3051 adjacently arranged along the third direction A3-A3. Each group of second signal contact pads 3051 is associated with two second ground contact pads 3052 which are located on two sides thereof respectively, so as to improve shielding and improve signal transmission quality. In the illustrated embodiment of the present disclosure, each group of second signal contact pads 3051 forms a differential pair to increase the speed of signal transmission. In the illustrated embodiment of the present disclosure, a length of each second ground contact pad 3052 along the first direction A1-A1 is greater than a length of each second signal contact pad 3051 along the first direction A1-A1, so as to better improve the shielding and improve the signal transmission quality.

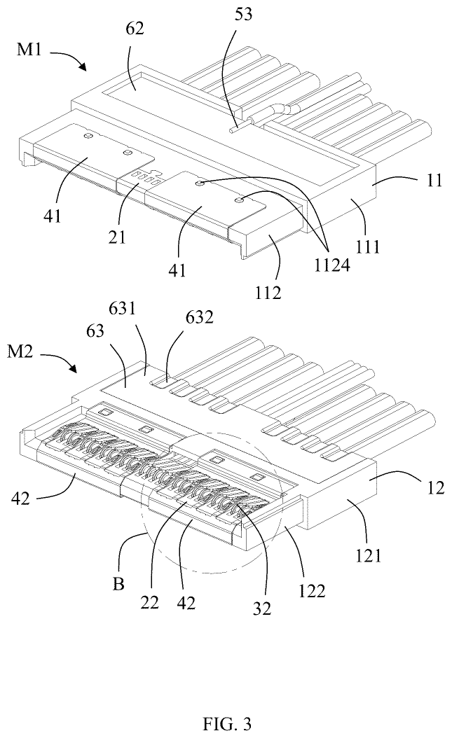

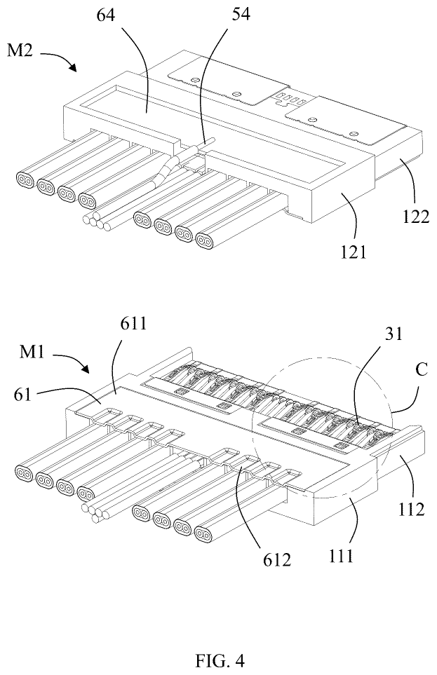

Referring to FIG. 1 to FIG. 4, in the illustrated embodiment of the present disclosure, the electrical connector 100 includes a first module M1 and a second module M2. The first module M1 and the second module M2 are separately arranged and fixed together. Preferably, the first module M1and the second module M2 are the same part, but have different installation angles to save costs.

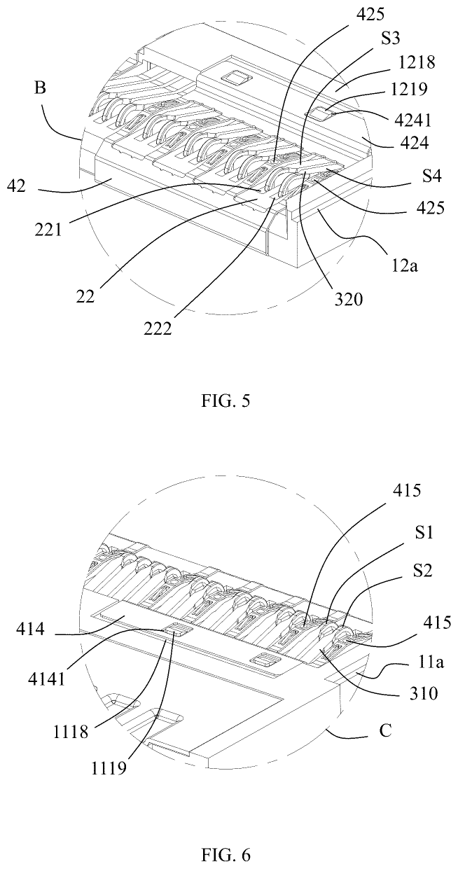

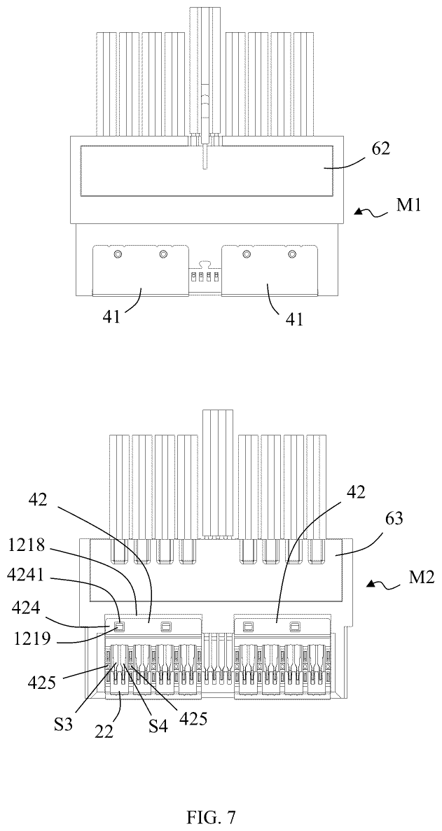

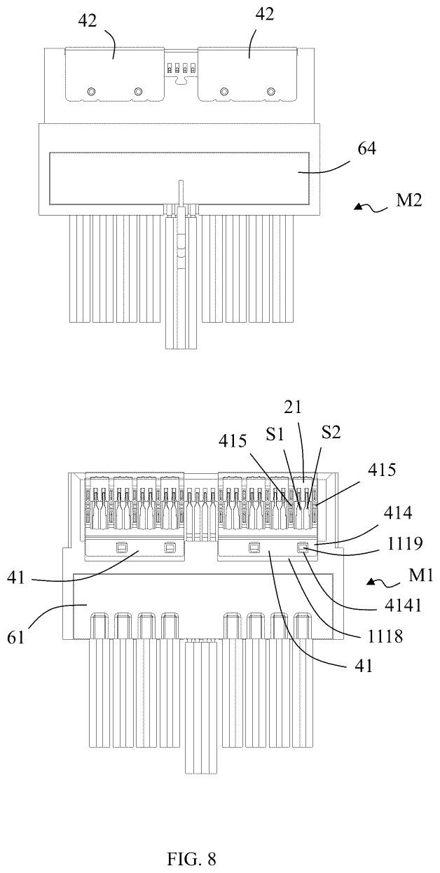

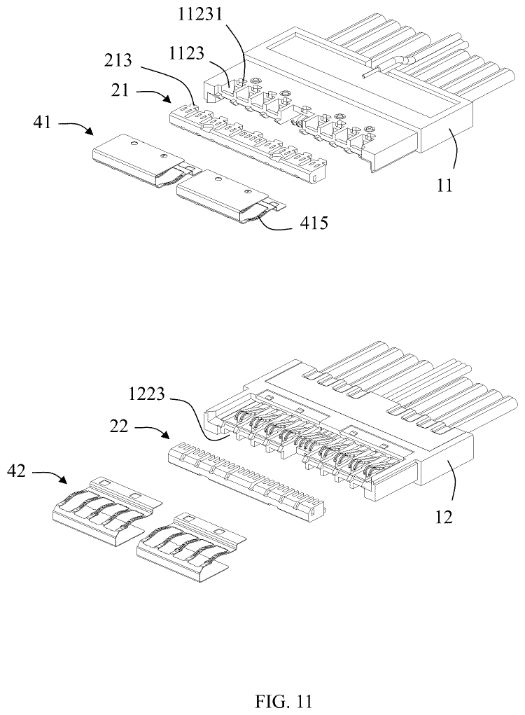

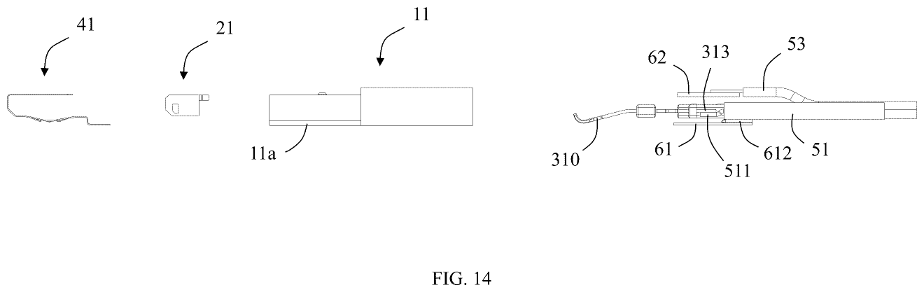

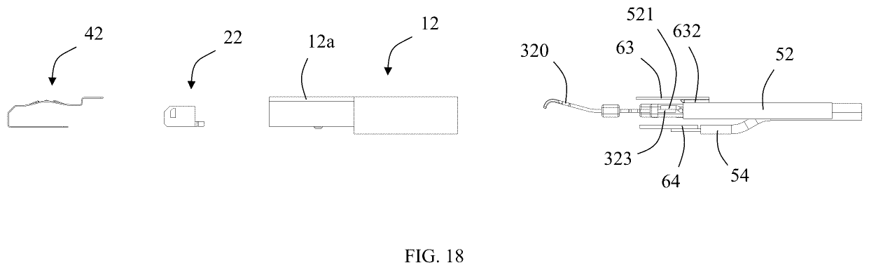

Referring to FIGS. 1 to 23, in one embodiment of the present disclosure, the electrical connector 100 includes a housing, an insulating fixing block 2 fixed to the housing, and a plurality of conductive terminals 3 installed to the housing.

In an embodiment of the present disclosure, the housing is a conductive housing 1. The conductive housing 1 is a metal housing made of metal material so as to further improve the shielding effect and improve the quality of signal transmission. In another embodiment of the present disclosure, the conductive housing 1 may also be a composite housing formed by electroplating a metal material on an insulating material. The composite housing can also improve the shielding effect and improve the quality of signal transmission.

As shown in FIG. 1 to FIG. 6, in an embodiment of the present disclosure, the conductive housing 1 includes a first conductive housing 11 and a second conductive housing 12. The first conductive housing 11 and the second conductive housing 12 are fixed together.

For example, after the first conductive housing 11 and the second conductive housing 12 are assembled, they are fixed together for example by welding or soldering or other methods. In the illustrated embodiment of the present disclosure, the first conductive housing 11 of the first module M1and the second conductive housing 12 of the second module M2 are separately arranged and fixed together to jointly form the receiving slot 101.

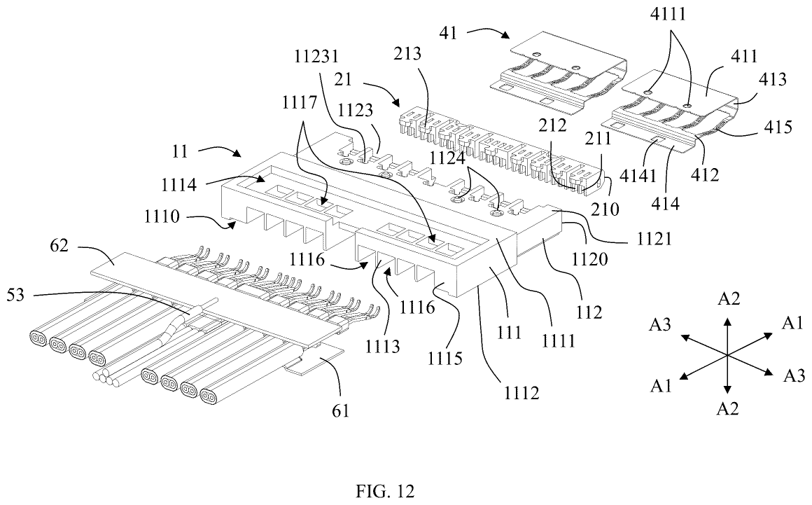

Referring to FIG. 12 to FIG. 15, in an embodiment of the present disclosure, the first conductive housing 11 includes a first base portion 111 and a first protruding portion 112 extending forwardly from the first base portion 111. The first base portion 111 includes a first upper surface 1111, a first lower surface 1112, a first rear surface 1115 and a plurality of first mounting grooves 1116 recessed forwardly from the first rear surface 1115. The plurality of first mounting grooves 1116 are spaced apart along the third direction A3-A3. Besides, the plurality of first mounting grooves 1116 extend downwardly through the first lower surface 1112. In the illustrated embodiment of the present disclosure, the first base portion 111 is further provided with a plurality of first barrier portions 1113. Any two adjacent first mounting grooves 1116 are separated by one first barrier portion 1113 located between the two first mounting grooves 1116 so as to improve the shielding effect and improve the quality of signal transmission. The first base portion 111 further defines a first receiving recess 1114 formed downwardly from the first upper surface 1111, a first mounting recess 1110 formed upwardly from the first lower surface 1112, and a plurality of first through holes 1117 communicating the first receiving recess 1114 and the plurality of first mounting grooves 1116 along the second direction A2-A2. The plurality of first through holes 1117 extend upwardly through the first upper surface 1111. In the illustrated embodiment of the present disclosure, the plurality of first through holes 1117 and the plurality of first mounting grooves 1116 are disposed in a one-to-one correspondence manner, and each first through hole 1117 communicates with a corresponding first mounting groove 1116 along the second direction A2-A2. Specifically, in the illustrated embodiment of the present disclosure, the first mounting grooves 1116 extend backwardly through the first rear surface 1115. The first mounting grooves 1116 communicate downwardly with the first mounting recess 1110. The first mounting recess 1110 extends downwardly through the first lower surface 1112. The first mounting grooves 1116 upwardly communicate with the first receiving recess 1114 through the first through holes 1117. The first receiving recess 1114 extends upwardly through the first upper surface 1111. Besides, a bottom of the first base portion 111 further includes at least one first recess 1118 adjacent to the first protruding portion 112. In the illustrated embodiment of the present disclosure, two first recesses 1118 are provided. The first base portion 111 further includes a plurality of first mounting protrusions 1119 protruding into corresponding first recesses 1118.

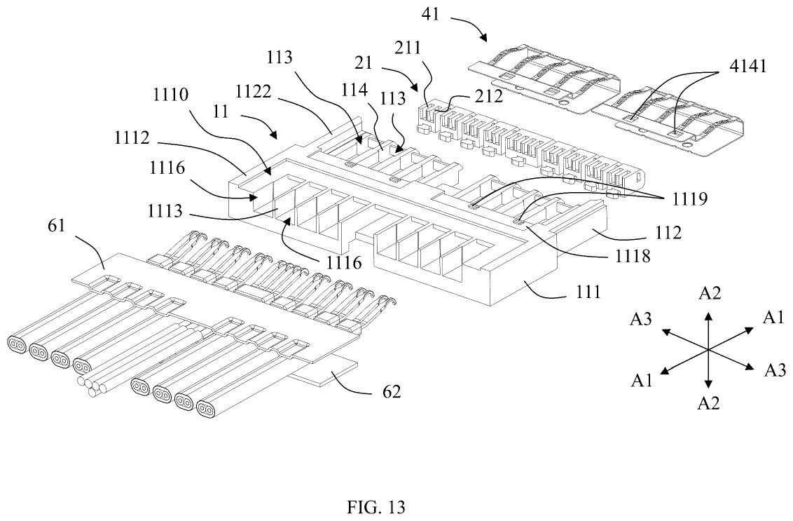

Referring to FIG. 12 and FIG. 13, the first protruding portion 112 includes a second upper surface 1121, a second lower surface 1122, and a plurality of first filling grooves 1123 extending upwardly through the second upper surface 1121 along the second direction A2-A2. The first filling grooves 1123 extend forwardly through a first front end surface 1120 of the first protruding portion 112 along the first direction A1-A1. The first protruding portion 112 further includes a plurality of first positioning posts 1124 protruding upwardly beyond the second upper surface 1121 along the second direction A2-A2.

Referring to FIG. 13, in the illustrated embodiment of the present disclosure, the first conductive housing 11 further includes a plurality of first terminal module installation slots 113 extending along the first direction A1-A1. Each first terminal module installation slot 113 extends from a portion of the first base portion 111 to the first protruding portion 112. A rear end of the first terminal module installation slot 113 communicates with the first mounting groove 1116. A middle portion of the first terminal module installation slot 113 is circumferentially surrounded by walls of the first conductive housing 11. A front end of the first terminal module installation slot 113 extends downwardly through the second lower surface 1122. Specifically, in the illustrated embodiment of the present disclosure, the first terminal module installation slot 113 includes a first surrounding groove 1131 close to a corresponding first mounting groove 1116 and a first open slot 1132 away from the corresponding first mounting groove 1116. The first surrounding groove 1131 is surrounded by wall portions of the first conductive housing 11 along a circumferential direction. The first open slot 1132 communicates with the receiving slot 101. It is understandable to those skilled in the art that by arranging the middle portion of the first terminal module installation slot 113 to be surrounded by the wall portions of the first conductive housing 11 in a circumferential direction, on the one hand, the conductive terminals located in the first terminal module installation slots 113 can be better shielded; and on the other hand, adjacent first terminal module installation slots 113 can be well separated, thereby reducing signal crosstalk.

As shown in FIG. 13, the plurality of first terminal module installation slots 113 are spaced apart along the third direction A3-A3. The first conductive housing 11 includes a plurality of first partition walls 114 disposed at intervals along the third direction A3-A3. Two adjacent first terminal module installation slots 113 are separated by a corresponding first partition wall 114 along the third direction A3-A3. In other words, each first terminal module installation slot 113 is surrounded by four walls of the first conductive housing 11 on a length corresponding to the corresponding first partition wall 114, thereby improving the shielding effect. With this arrangement, each first terminal module installation slot 113 is relatively independent, thereby reducing signal crosstalk and improving the quality of data transmission.

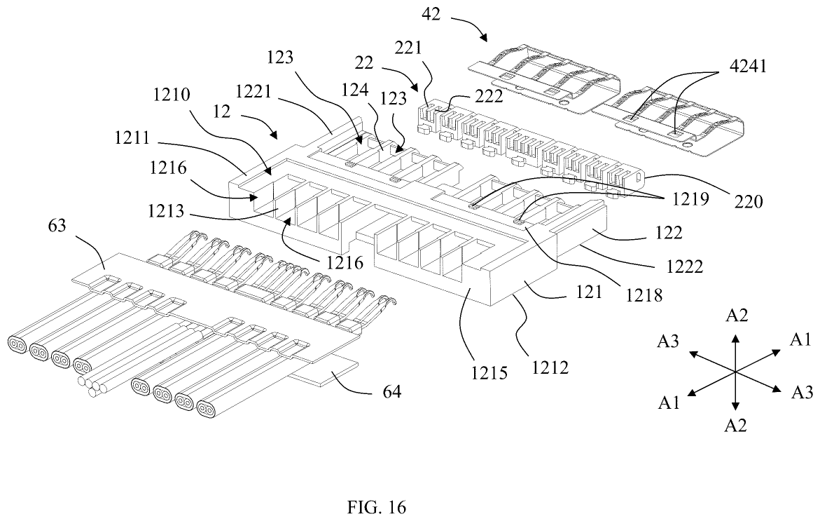

Referring to FIG. 16 to FIG. 19, in an embodiment of the present disclosure, the second conductive housing 12 includes a second base portion 121 and a second protruding portion 122 extending forwardly from the second base portion 121. The second base portion 121 includes a third upper surface 1211, a third lower surface 1212, a second rear surface 1215 and a plurality of second mounting grooves 1216 recessed forwardly from the second rear surface 1215. The plurality of second mounting grooves 1216 are spaced apart along the third direction A3-A3. The plurality of second mounting grooves 1216 extend through the second base portion 121 along the top-bottom direction. The plurality of second mounting grooves 1216 extend upwardly through the third upper surface 1211. In the illustrated embodiment of the present disclosure, the second base portion 121 is further provided with a plurality of second barrier portions 1213. Any two adjacent second mounting grooves 1216 are separated by one second barrier portion 1213 located between the two second mounting grooves 1216 to improve the shielding effect and improve the quality of signal transmission. The second base portion 121 further defines a second receiving recess 1214 formed upwardly from the third lower surface 1212, a second mounting recess 1210 formed downwardly from the third upper surface 1211, and a plurality of second through holes 1217 communicating with the second receiving recess 1214 and the plurality of second mounting grooves 1216. The plurality of second through holes 1217 extend downwardly through the third lower surface 1212. In the illustrated embodiment of the present disclosure, the plurality of second through holes 1217 and the plurality of second mounting grooves 1216 are disposed in a one-to-one correspondence manner, and each second through hole 1217 communicates with a corresponding second mounting groove 1216 along the second direction A2-A2. Specifically, in the illustrated embodiment of the present disclosure, the second mounting grooves 1216 extend backwardly through the second rear surface 1215. The second mounting grooves 1216 upwardly communicate with the second mounting recess 1210. The second mounting recess 1210 extends upwardly through the third upper surface 1211. The second mounting grooves 1216 communicate downwardly with the second receiving recess 1214 through the second through holes 1217. The second receiving recess 1214 extends downwardly through the third lower surface 1212. Besides, a top of the second base portion 121 further defines at least one second recess 1218 adjacent to the second protruding portion 122. In the illustrated embodiment of the present disclosure, two second recesses 1218 are provided. The second base portion 121 further includes a plurality of second mounting protrusions 1219 protruding into corresponding second recesses 1218.

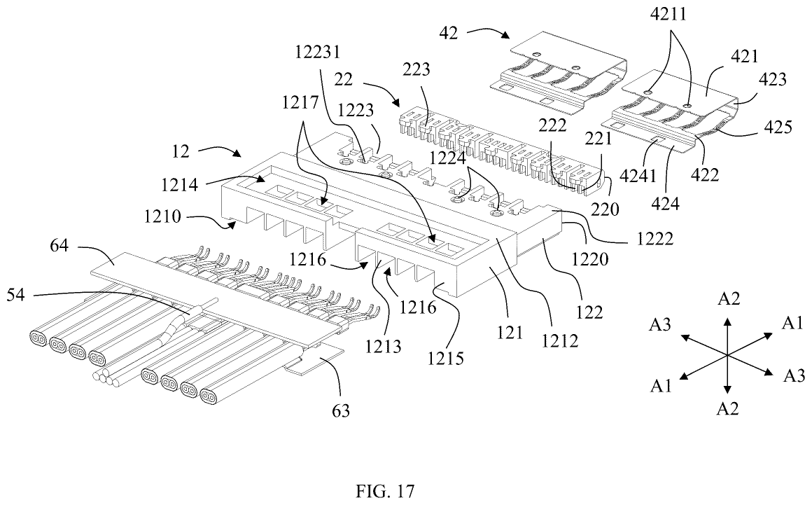

Referring to FIG. 16 and FIG. 17, the second protruding portion 122 includes a fourth upper surface 1221, a fourth lower surface 1222, and a plurality of second filling grooves 1223 extending downwardly through the fourth lower surface 1222. The second filling grooves 1223 extend forwardly through a second front end surface 1220 of the second protruding portion 122. The second protruding portion 122 further includes a plurality of second positioning posts 1224 protruding downwardly beyond the second lower surface 1122.

Referring to FIG. 16, in the illustrated embodiment of the present disclosure, the second conductive housing 12 further includes a plurality of second terminal module installation slots 123 extending along the first direction A1-A1. Each second terminal module installation slot 123 extends from the second base portion 121 to the second protruding portion 122. A rear end of the second terminal module installation slot 123 communicates with the second mounting groove 1216. The middle portion of the second terminal module installation slot 123 is circumferentially surrounded by walls of the second conductive housing 12. A front end of the second terminal module installation slot 123 extends upwardly through the fourth upper surface 1221. Specifically, in the illustrated embodiment of the present disclosure, the second terminal module installation slot 123 includes a second surrounding groove 1231 close to a corresponding second mounting groove 1216 and a second open slot 1232 away from the corresponding second mounting groove 1216. The second surrounding groove 1231 is surrounded by wall portions of the second conductive housing 12 along a circumferential direction. The second open slot 1232 communicates with the receiving slot 101. It is understandable to those skilled in the art that by arranging the middle portion of the second terminal module installation slot 123 to be surrounded by the wall portions of the second conductive housing 12 in a circumferential direction; on the one hand, the conductive terminals located in the second terminal module installation slots 123 can be better shielded; and on the other hand, the adjacent second terminal module installation slots 123 can be well separated, thereby reducing signal crosstalk.

As shown in FIG. 16, the plurality of second terminal module installation slots 123 are arranged at intervals along the third direction A3-A3. The second conductive housing 12 includes a plurality of second partition walls 124 disposed at intervals along the third direction A3-A3. Two adjacent second terminal module installation slots 123 are separated by corresponding second partition walls 124 along the third direction A3-A3. In other words, each second terminal module installation slot 123 is surrounded by four walls of the second conductive housing 12 on a length corresponding to the second partition wall 124, thereby improving the shielding effect. With this arrangement, each second terminal module installation slot 123 is relatively independent, thereby reducing signal crosstalk and improving the quality of data transmission.

Referring to FIG. 1 to FIG. 19, in the illustrated embodiment of the present disclosure, the insulating fixing block 2 includes a first insulating fixing block 21 and a second insulating fixing block 22. The first insulating fixing block 21 is fixed in the first filling grooves 1123. The second insulating fixing block 22 is fixed in the second filling grooves 1223. Preferably, in order to increase the bonding force between the first insulating fixing block 21 and the first conductive housing 11, the first insulating fixing block 21 is molded in the first filling grooves 1123. Similarly, in order to increase the bonding force between the second insulating fixing block 22 and the second conductive housing 12, the second insulating fixing block 22 is molded in the second filling grooves 1223. The first insulating fixing block 21 is provided with a first dovetail protrusion 213. The first filling groove 1123 is provided with a first dovetail groove 11231. When the first dovetail protrusion 213 is clamped into the first dovetail groove 11231, the first insulating fixing block 21 can be prevented from falling off from the first conductive housing 11 in the first direction A1-A1. Similarly, the second insulating fixing block 22 is provided with a second dovetail protrusion 223. The second filling groove 1223 is provided with a second dovetail groove 12231. When the second dovetail protrusion 223 is clamped into the second dovetail groove 12231, the second insulating fixing block 22 can be prevented from falling off from the second conductive housing 12 in the first direction A1-A1.

The first insulating fixing block 21 defines a plurality of first slits 211 and a plurality of second slits 212, in which adjacent first slit 211 and second slit 212 form a group and communicate with a corresponding first terminal module installation slot 113. The first insulating fixing block 21 further includes a first front surface 210 which is coplanar with the first front end surface 1120 of the first protruding portion 112.

Similarly, the second insulating fixing block 22 defines a plurality of third slits 221 and a plurality of fourth slits 222. Adjacent third slit 221 and fourth slit 222 form a group and communicate with a corresponding second terminal module installation slot 123. The second insulating fixing block 22 includes a second front surface 220 which is coplanar with the second front end surface 1220 of the second protruding portion 122.

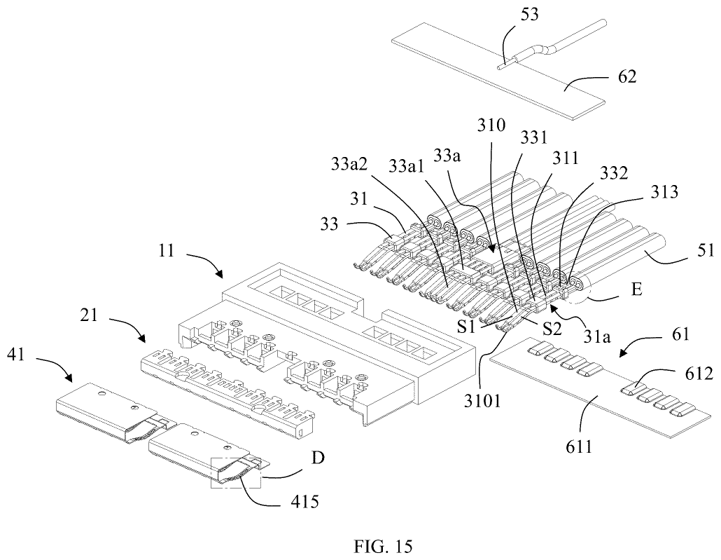

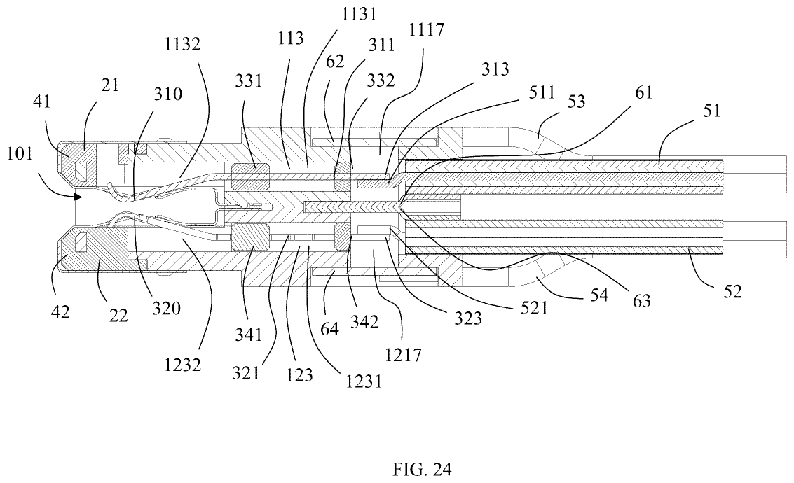

As shown in FIG. 15 to FIG. 24, the plurality of conductive terminals 3 include a plurality of first conductive terminals 31 and a plurality of second conductive terminals 32. Each first conductive terminal 31 includes a first fixing portion 311 extending along the first direction A1-A1, a first contact arm 310 extending forwardly from a front end of the first fixing portion 311, and a first tail portion 313 extending backwardly from a rear end of the first fixing portion 311. The first fixing portion 311 is at least partially located in the first surrounding groove 1131. The first contact arm 310 is at least partially located in the first open slot 1132. The first tail portion 313 is at least partially located in the first mounting groove 1116. The first contact arm 310 includes a first contact portion 3101 that passes through the first open slot 1132 and extends into the receiving slot 101. The first contact portions 3101 are configured to be in contact with the first signal contact pads 3041 of the tongue plate 301. In the illustrated embodiment of the present disclosure, the first tail portions 313 extend backwardly and horizontally to be electrically connected to first cables 51.

Referring to FIG. 15, in the illustrated embodiment of the present disclosure, the plurality of first conductive terminals 31 are divided into a plurality of groups. Each group of first conductive terminals 31 includes a first signal terminal S1 and a second signal terminal S2 located adjacent to the first signal terminal S1. Preferably, the first signal terminal S1 and the second signal terminal S2 in each group of first conductive terminals 31 form a differential pair to improve signal transmission speed, thereby being suitable for high-speed signal transmission.

In the illustrated embodiment of the present disclosure, the electrical connector 100 further includes a first holding block 33 fixed on the first signal terminal S1 and the second signal terminal S2 of each group of first conductive terminals 31. In an embodiment of the present disclosure, the first signal terminal S1 and the second signal terminal S2 are insert-molded with the first holding block 33, so as to form an integrated first terminal module 31a. The first contact portions 3101 of the first signal terminal S1 and the second signal terminal S2 in each first terminal module 31a are configured to be in contact with the first signal contact pads 3041 of the mating module 300, respectively.

In the illustrated embodiment of the present disclosure, the first holding block 33 includes a first fixing block 331 fixed on middle portions of the first fixing portions 311 of the first signal terminal S1 and the second signal terminal S2, and a second fixing block 332 fixed on rear ends of the first fixing portions 311 of the first signal terminal S1 and the second signal terminal S2. The first fixing block 331 and the second fixing block 332 are installed and fixed in the first terminal module installation slot 113, which prevents the first conductive terminal 31 from contacting the first conductive housing 11 to cause a short circuit. The first tail portion 313 extends backwardly into the first mounting groove 1116 to facilitate connection with the first cable 51.

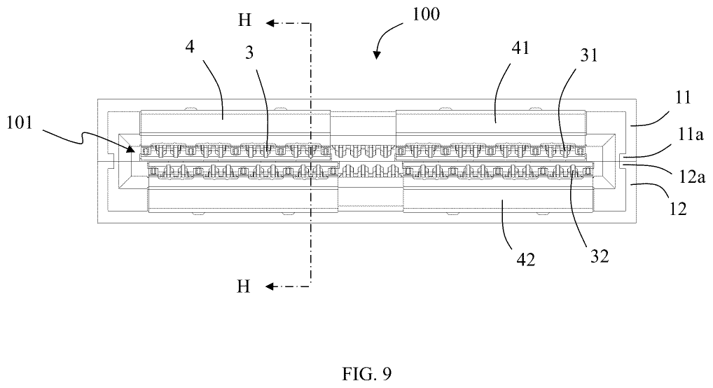

Similarly, referring to FIG. 9, each second conductive terminal 32 includes a second fixing portion 321 extending along the first direction A1-A1, a second contact arm 320 extending forwardly from a front end of the second fixing portion 321, and a second tail portion 323 extending backwardly from a rear end of the second fixing portion 321. The second fixing portion 321 is at least partially located in the second surrounding groove 1231. The second contact arm 320 is located at least partially in the second open slot 1232. The second tail portion 323 is at least partially located in the second mounting groove 1216. The second contact arm 320 includes a second contact portion 3201 that passes through the second open slot 1232 and extends into the receiving slot 101. The second contact portions 3201 are configured to be in contact with the second signal contact pads 3051 of the tongue plate 301. In the illustrated embodiment of the present disclosure, the second tail portions 323 extend backwardly and horizontally from the second fixing portions 321 to be electrically connected to second cables 52.

In the illustrated embodiment of the present disclosure, the plurality of second conductive terminals 32 are divided into a plurality of groups, and each group of second conductive terminals 32 includes a third signal terminal S3 and a fourth signal terminal S4 located adjacent to the third signal terminal S3. Preferably, the third signal terminal S3 and the fourth signal terminal S4 in each group of second conductive terminals 32 form a differential pair to improve signal transmission speed, thereby being suitable for high-speed signal transmission.

In the illustrated embodiment of the present disclosure, the electrical connector 100 further includes a second holding block 34 fixed on the third signal terminal S3 and the fourth signal terminal S4 of each group of second conductive terminals 32. In one embodiment of the present disclosure, the third signal terminal S3 and the fourth signal terminal S4 are insert-molded with the second holding block 34 to form an integrated second terminal module 32a. The second contact portions 3201 of the third signal terminal S3 and the fourth signal terminal S4 in each second terminal module 32a are configured to be in contact with the second signal contact pads 3051 of the mating module 300.

In the illustrated embodiment of the present disclosure, the second holding block 34 includes a third fixing block 341 fixed at middle portions of the second fixing portions 321 of the third signal terminal S3 and the fourth signal terminal S4, and a fourth fixing block 342 fixed at rear ends of the second fixing portions 321 of the third signal terminal S3 and the fourth signal terminal S4. The third fixing block 341 and the fourth fixing block 342 are installed and fixed in the second terminal module installation slot 123, which prevents the second conductive terminal 32 from contacting the second conductive housing 12 to cause a short circuit. The second tail portions 323 extend backwardly into the second mounting grooves 1216 to facilitate connection with the second cables 52.

As shown in FIG. 15, in the illustrated embodiment of the present disclosure, the electrical connector 100 further includes a first non-high-speed terminal module 33a and a second non-high-speed terminal module 34a. The first non-high-speed terminal module 33a includes a first insulating block 33a1 and a plurality of first non-high-speed terminals 33a2 fixed to the first insulating block 33a1. It is understandable to those skilled in the art that the first non-high-speed terminals 33a2 include but are not limited to non-high-speed signal terminals, power terminals, etc.

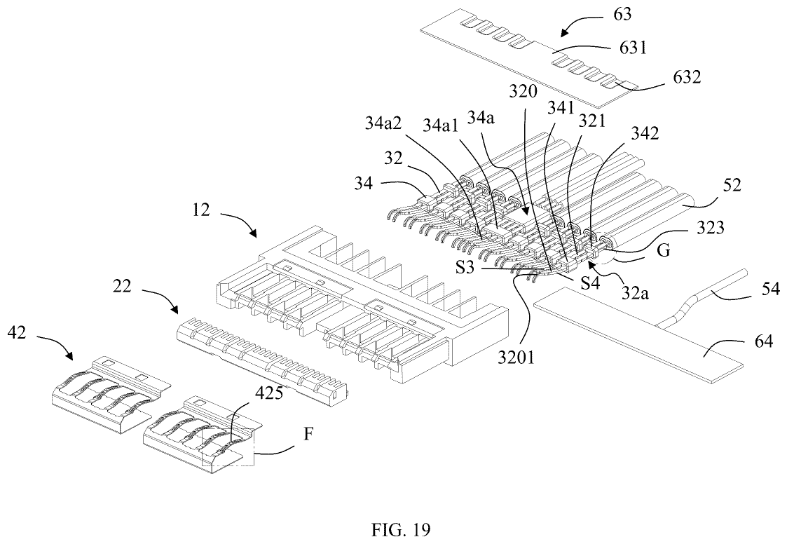

Similarly, as shown in FIG. 19, the second non-high-speed terminal module 34a includes a second insulating block 34a1 and a plurality of second non-high-speed terminals 34a2 fixed to the second insulating block 34a1. It is understandable to those skilled in the art that the second non-high-speed terminals 34a2 include but are not limited to non-high-speed signal terminals, power terminals, etc.

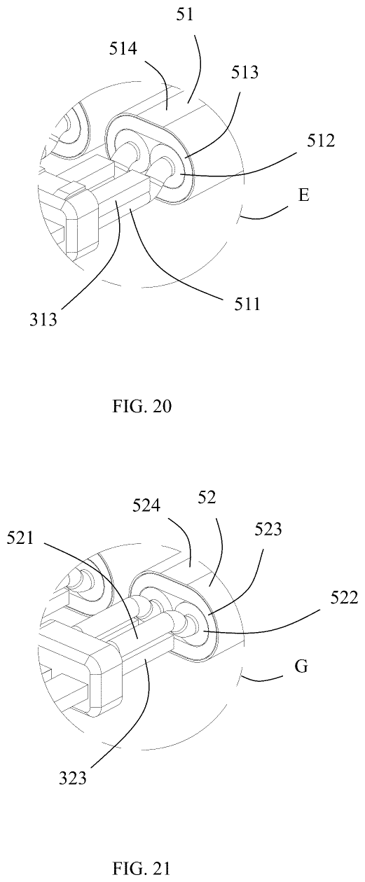

Referring to FIG. 20, in the illustrated embodiment of the present disclosure, the first cable 51 includes a first core 511, a first insulator 512 wrapped around the first core 511, a first shielding layer 513 (such as a shielding braid) wrapped around the first insulator 512, and a first insulation skin 514 wrapped around the first shielding layer 513.

Similarly, as shown in FIG. 21, the second cable 52 includes a second core 521, a second insulator 522 wrapped around the second core 521, a second shielding layer 523 (such as a shielding braid) wrapped around the second insulator 522, and a second insulation skin 524 wrapped around the second shielding layer 523.

Referring to FIG. 1 to FIG. 24, in one embodiment of the present disclosure, the electrical connector 100 further includes at least one ground sheet 4 mounted to the conductive housing 1. The ground sheet 4 includes a first ground sheet 41 and a second ground sheet 42. In the illustrated embodiment of the present disclosure, two first ground sheets 41 are provided and they are made of metal material. Two second ground sheets 42 are provided and they are made of metal material.

Referring to FIG. 12 and FIG. 13, each first ground sheet 41 is generally U-shaped and includes a first mounting plate 411, a second mounting plate 412 opposite to the first mounting plate 411, a first connecting plate 413 connecting one side of the first mounting plate 411 and one side of the second mounting plate 412, and a first extension plate 414 extending downwardly and backwardly from another side of the second mounting plate 412. The first mounting plate 411 defines a plurality of first mounting positioning holes 4111 that match the first positioning posts 1124. The first extension plate 414 is received in a corresponding first recess 1118 of the first conductive housing 11. The first extension plate 414 defines a plurality of first mounting holes 4141 to receive the first mounting protrusions 1119.

The first connecting plate 413 abuts against and at least partially covers the first front surface 210 of the first insulating fixing block 21. The first connecting plate 413 is located at a front end of the receiving slot 101 along the first direction A1-A1. When the mating module 300 is inserted, the tongue plate 301 may be in contact with the first connecting plate 413 first, thereby facilitating the discharge of static electricity. The second mounting plate 412 is provided with a plurality of first grounding elastic arms 415 which are disposed at intervals along the third direction A3-A3. The first grounding elastic arms 415 are disposed on two sides of the first contact arms 310 of each group of first conductive terminals 31 so as to improve the shielding effect and improve the quality of signal transmission.

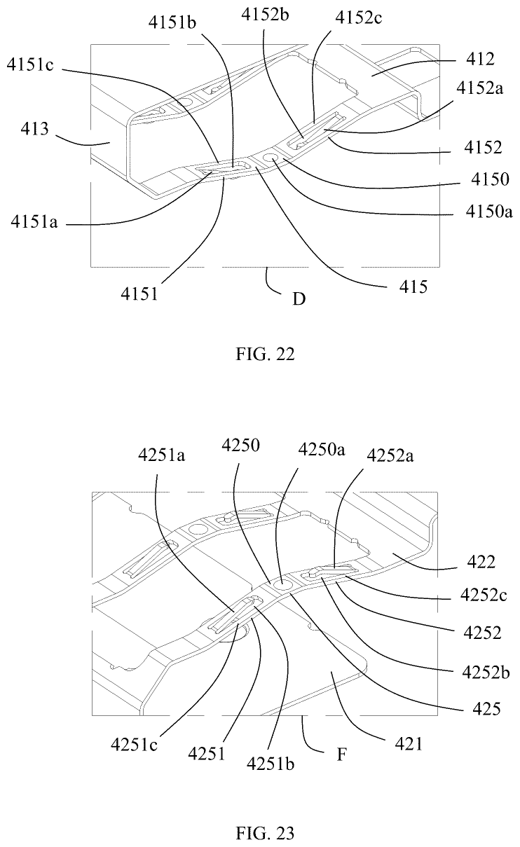

Referring to FIG. 22, the first grounding elastic arm 415 as a whole bulges away from the first mounting plate 411. Specifically, in the illustrated embodiment of the present disclosure, the first grounding elastic arm 415 includes a first intermediate portion 4150, a first elastic arm portion 4151 connecting one end of the first intermediate portion 4150 and the first connecting plate 413, and a second elastic arm portion 4152 connecting another end of the first intermediate portion 4150 and the first extension plate 414. In one embodiment of the present disclosure, the first intermediate portion 4150 includes a first dimple 4150a protruding into the receiving slot 101. The first elastic arm portion 4151 is provided with a first contact elastic arm 4151a extending toward the first intermediate portion 4150, and a first relief groove 4151b corresponding to the first contact elastic arm 4151a and providing a deformation space for the first contact elastic arm 4151a. The second elastic arm portion 4152 is provided with a second contact elastic arm 4152a extending toward the first intermediate portion 4150, and a second relief groove 4152b corresponding to the second contact elastic arm 4152a and providing a deformation space for the second contact elastic arm 4152a. In the illustrated embodiment of the present disclosure, the first contact elastic arm 4151a and the second contact elastic arm 4152a are located on two sides of the first intermediate portion 4150, respectively. The first contact elastic arm 4151a and the second contact elastic arm 4152a are aligned along the first direction A1-A1. A free end of the first contact elastic arm 4151a and a free end of the second contact elastic arm 4152a are both located adjacent to the first intermediate portion 4150. The first contact elastic arm 4151a, the first dimple 4150a and the second contact elastic arm 4152a are all in contact with the corresponding first ground contact pad 3042 of the mating module 300. This three-point contact method is beneficial to achieve better shielding effect.

In one embodiment of the present disclosure, the first elastic arm portion 4151 includes a first frame 4151c that is surrounded by all sides. The first relief groove 4151b is a closed groove and is surrounded by the first frame 4151c. The first contact elastic arm 4151a is connected to a wall of the first frame 4151c. The other three walls of the first frame 4151c respectively surround the other three sides of the first contact elastic arm 4151a. In an embodiment of the present disclosure, by arranging the first frame 4151c surrounding the first contact elastic arm 4151a, it can provide better protection for the first contact elastic arm 4151a and prevent the first contact elastic arm 4151a from being excessively deformed.

Similarly, the second elastic arm portion 4152 includes a second frame 4152c that is surrounded by all sides. The second relief groove 4152b is a closed groove and is surrounded by the second frame 4152c. The second contact elastic arm 4152a is connected to a wall of the second frame 4152c. The other three walls of the second frame 4152c respectively surround the other three sides of the second contact elastic arm 4152a. In one embodiment of the present disclosure, by arranging the second frame 4152c surrounding the second contact elastic arm 4152a, it can provide better protection for the second contact elastic arm 4152a and prevent the second contact elastic arm 4152a from being excessively deformed.

In an embodiment of the present disclosure, the first positioning posts 1124 are fixed to the first mounting positioning holes 4111, so that the first mounting plate 411 is fixed to the second upper surface 1121 of the first protruding portion 112. As shown in FIG. 21, a dimension of the first mounting hole 4141 along the first direction A1-A1 may be slightly larger than a dimension of the first mounting protrusion 1119 along the first direction A1-A1. Therefore, when the first contact elastic arm 4151a, the first intermediate portion 4150 and the second contact elastic arm 4152a are contacted and deformed by the first ground contact pad 3042 of the mating module 300, the first extension plate 414 can move appropriately in the first recess 1118 along the first direction A1-A1.

Referring to FIG. 15 to FIG. 19, each second ground sheet 42 is generally U-shaped and includes a third mounting plate 421, a fourth mounting plate 422 opposite to the third mounting plate 421, a second connecting plate 423 connecting one side of the third mounting plate 421 and one side of the fourth mounting plate 422, and a second extension plate 424 extending downwardly and backwardly from another side of the fourth mounting plate 422. The third mounting plate 421 defines a plurality of second mounting positioning holes 4211 that match the second positioning posts 1224. The second extension plate 424 is received in a corresponding second recess 1218 of the second conductive housing 12. The second extension plate 424 defines a plurality of second mounting holes 4241 to receive the second mounting protrusions 1219.

The second connecting plate 423 abuts against and at least partially covers the second front surface 220 of the second insulating fixing block 22. The second connecting plate 423 is located at the front end of the receiving slot 101 along the first direction A1-A1. When the mating module 300 is inserted, the tongue plate 301 may be in contact with the second connecting plate 423 first, thereby facilitating the discharge of static electricity. The fourth mounting plate 422 is provided with a plurality of second grounding elastic arms 425 which are disposed at intervals along the third direction A3-A3. The second grounding elastic arms 425 are disposed on two sides of the second contact arms 320 of each group of second conductive terminals 32, respectively, so as to improve the shielding effect and improve the quality of signal transmission.

Referring to FIG. 23, the second grounding elastic arm 425 bulges away from the third mounting plate 421 as a whole. Specifically, in the illustrated embodiment of the present disclosure, the second grounding elastic arm 425 includes a second intermediate portion 4250, a third elastic arm portion 4251 connecting one end of the second intermediate portion 4250 and the second connecting plate 423, and a fourth elastic arm portion 4252 connecting another end of the second intermediate portion 4250 and the second extension plate 424. In one embodiment of the present disclosure, the second intermediate portion 4250 includes a second dimple 4250a protruding into the receiving slot 101. The third elastic arm portion 4251 includes a third contact elastic arm 4251a extending toward the second intermediate portion 4250, and a third relief groove 425 1b corresponding to the third contact elastic arm 4251a and providing a deformation space for the third contact elastic arm 4251a. The fourth elastic arm portion 4252 includes a fourth contact elastic arm 4252a extending toward the second intermediate portion 4250, and a fourth relief groove 4252b corresponding to the fourth contact elastic arm 4252a and providing a deformation space for the fourth contact elastic arm 4252a. In the illustrated embodiment of the present disclosure, the third contact elastic arm 4251a and the fourth contact elastic arm 4252a are located on two sides of the second intermediate portion 4250, respectively. The third contact elastic arm 4251a and the fourth contact elastic arm 4252a are aligned along the first direction A1-A1. A free end of the third contact elastic arm 4251a and a free end of the fourth contact elastic arm 4252a are both adjacent to the second intermediate portion 4250. The third contact elastic arm 4251a, the second dimple 4250a and the fourth contact elastic arm 4252a are all in contact with the second ground contact pad 3052 of the mating module 300. This three-point contact method is beneficial to achieve better shielding effect.

In one embodiment of the present disclosure, the third elastic arm portion 4251 includes a third frame 4251c that is surrounded by all sides. The third relief groove 4251b is a closed groove and is surrounded by the third frame 4251c. The third contact elastic arm 4251a is connected to a wall of the third frame 4251c. The other three walls of the third frame 4251c respectively surround the other three sides of the third contact elastic arm 4251a. In one embodiment of the present disclosure, by arranging the third frame 4251c surrounding the third contact elastic arm 4251a, it can provide better protection for the third contact elastic arm 4251a and prevent the third contact elastic arm 4251a from being excessively deformed.

Similarly, the fourth elastic arm portion 4252 includes a surrounding fourth frame 4252c. The fourth relief groove 4252b is a closed groove and is surrounded by the fourth frame 4252c. The fourth contact elastic arm 4252a is connected to a wall of the fourth frame 4252c. The other three walls of the fourth frame 4252c respectively surround the other three sides of the fourth contact elastic arm 4252a. In one embodiment of the present disclosure, by arranging the fourth frame 4252c surrounding the fourth contact elastic arm 4252a, it can provide better protection for the fourth contact elastic arm 4252a and prevent the fourth contact elastic arm 4252a from being excessively deformed.

In an embodiment of the present disclosure, the second positioning posts 1224 are fixed in the second mounting positioning holes 4211, so that the third mounting plate 421 is fixed to the fourth lower surface 1222 of the second protruding portion 122. As shown in FIG. 20, a dimension of the second mounting hole 4241 along the first direction A1-A1 may be slightly larger than a dimension of the second mounting bump 1219 along the first direction A1-A1. Therefore, when the third contact elastic arm 4251a, the second intermediate portion 4250 and the fourth contact elastic arm 4252a are contacted and deformed by the second ground contact pad 3052 of the mating module 300, the second extension plate 424 can move appropriately in the second recess 1218 along the first direction A1-A1.

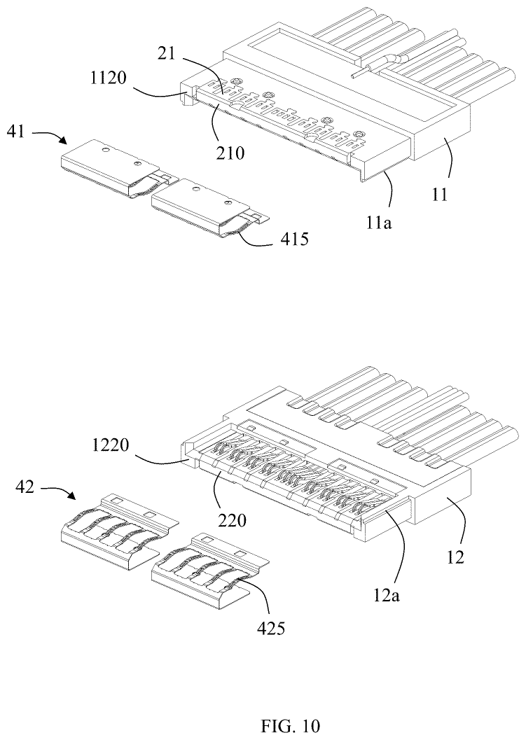

Referring to FIG. 10 to FIG. 19, in the illustrated embodiment of the present disclosure, the first module M1 further includes a first shielding plate 61 installed on the first conductive housing 11 and a first shielding cover 62 installed on the first conductive housing 11. In an embodiment of the present disclosure, the first shielding plate 61 is a metal shielding plate, and the first shielding cover 62 is a metal shielding cover. The first shielding plate 61 includes a first main body portion 611 installed in the first mounting recess 1110 and a plurality of first protrusions 612 integrally stamped from the first main body portion 611. By installing the first shielding plate 61, the downwardly open first mounting grooves 1116 can be better shielded, thereby improving the shielding effect. In the illustrated embodiment of the present disclosure, a lower surface of the first main body portion 611 is flush with the first lower surface 1112 of the first conductive housing 11. The first protrusions 612 protrude into the first terminal module installation slots 113 to be in contact with corresponding first cables 51. In an embodiment of the present disclosure, the first protrusion 612 abuts against the first insulation skin 514 of the first cable 51 to maintain position of the first cable 51. Of course, in other embodiments of the present disclosure, the first protrusion 612 can also abut against the first shielding layer 513 of the first cable 51 to not only maintain the position of the first cable 51, but also improve the grounding shielding effect.

The first shielding cover 62 is installed in the first receiving recess 1114 to cover the first through holes 1117, thereby improving the shielding effect.

In the illustrated embodiment of the present disclosure, the electrical connector 100 further includes a first ground cable 53. The first ground cable 53 is in contact with the first shielding cover 62. In an embodiment of the present disclosure, the first ground cable 53 is fixed to the first shielding cover 62 by soldering or welding.

Referring to FIG. 10 to FIG. 19, in the illustrated embodiment of the present disclosure, the second module M2 further includes a second shielding plate 63 installed on the second conductive housing 12 and a second shielding cover 64 installed on the second conductive housing 12. In an embodiment of the present disclosure, the second shielding plate 63 is a metal shielding plate, and the second shielding cover 64 is a metal shielding cover. The second shielding plate 63 includes a second main body portion 631 installed in the second mounting recess 1210 and a plurality of second protrusions 632 integrally stamped from the second main body portion 631. By installing the second shielding plate 63, the downwardly open second mounting grooves 1216 can be better shielded, thereby improving the shielding effect. In the illustrated embodiment of the present disclosure, an upper surface of the second main body portion 631 is flush with the third upper surface 1211 of the second conductive housing 12. The second protrusions 632 protrude into the second terminal module installation slots 123 to be in contact with corresponding second cables 52. In one embodiment of the present disclosure, the second protrusion 632 abuts against the second insulation skin 524 of the second cable 52 to maintain the position of the second cable 52. Of course, in other embodiments of the present disclosure, the second protrusion 632 can also abut against the second shielding layer 523 of the second cable 52 to not only maintain the position of the second cable 52, but also improve the grounding shielding effect.

The second shielding cover 64 is installed in the second receiving recess 1214 to cover the second through holes 1217, thereby improving the shielding effect.

In the illustrated embodiment of the present disclosure, the electrical connector 100 further includes a second ground cable 54. The second ground cable 54 is in contact with the second shielding cover 64. In one embodiment of the present disclosure, the second ground cable 54 is fixed to the second shielding cover 64 by soldering or welding.

When assembling the electrical connector 100, firstly, the first insulating fixing block 21 is fixed in the first filling grooves 1123, and the second insulating fixing block 22 is fixed in the second filling grooves 1223.

Then, the first terminal modules 31a and the second terminal modules 32a are installed in the corresponding first terminal module installation slots 113 and the second terminal installation slots 123 from back to front along the first direction A1-A1. At this time, the first fixing block 331 and the second fixing block 332 are fixed in the corresponding first terminal module installation slot 113, the first fixing portions 311 of the first conductive terminals 31 are disposed overhead in the corresponding first terminal module installation slot 113, in order to avoid short circuit due to contact with the first conductive housing 11. The first contact arm 310 of the first signal terminal S1 at least partially extends into the first slit 211 of the first insulating fixing block 21. The first contact arm 310 of the second signal terminal S2 at least partially extends into the second slit 212 of the first insulating fixing block 21. Similarly, the third fixing block 341 and the fourth fixing block 342 are installed in the corresponding second terminal module installation slot 123, the second fixing portions 321 of the second conductive terminal 32 are disposed overhead in the second terminal module installation slot 123, in order to avoid short circuit due to contact with the second conductive housing 12. The second contact arm 320 of the third signal terminal S3 at least partially extends into the third slit 221 of the second insulating fixing block 22. The second contact arm 320 of the fourth signal terminal S4 at least partially extends into the fourth slit 222 of the second insulating fixing block 22. At this time, the first tail portion 313 of the first conductive terminal 31 is backwardly exposed in the first mounting groove 1116, and the second tail portion 323 of the second conductive terminal 32 is backwardly exposed in the second mounting groove 1216.

Then, the first cables 51 and the second cables 52 are inserted into the corresponding first mounting grooves 1116 and the second mounting grooves 1216 from back to front along the first direction A1-A1. Alternatively, the first cables 51 and the second cables 52 can be disposed in the corresponding first mounting grooves 1116 and the corresponding second mounting grooves 1216 along the second direction A2-A2. The first core 511 of the first cable 51 is in contact with the first tail portion 313 of the first conductive terminal 31. The second core 521 of the second cable 52 is in contact with the second tail portion 323 of the second conductive terminal 32.

In the illustrated embodiment of the present disclosure, the first cables 51 and the second cables 52 are inserted into the corresponding first mounting grooves 1116 and the second mounting grooves 1216 from back to front along the first direction A1-A1. The first core 511 of the first cable 51 is located at a bottom of the first tail portion 313 of the first conductive terminal 31. The second core 521 of the second cable 52 is located on a top of the second tail portion 323 of the second conductive terminal 32. Preferably, in an embodiment of the present disclosure, the first core 511 of the first cable 51 and the first tail 313 of the first conductive terminal 31 are fixed by soldering or welding. The second core 521 of the second cable 52 and the second tail 323 of the second conductive terminal 32 are fixed by soldering or welding.

In order to better perform soldering or welding, in one embodiment of the present disclosure, a first clamp tool (not shown) is provided to extend into the first mounting recess 1110 to support the first cable 51; a second clamp tool (not shown) is provided and inserted into the first through hole 1117 along the second direction A2-A2 to abut against the first tail portion 313 of the first conductive terminal 31. At this time, the first tail portion 313 of the first conductive terminal 31 and the first core 511 of the first cable 51 are clamped between the first clamp tool and the second clamp tool. Therefore, the contact reliability between the first tail portion 313 of the first conductive terminal 31 and the first core 511 of the first cable 51 is improved, and the soldering or welding yield can be improved.

Similarly, in order to better perform soldering or welding, in one embodiment of the present disclosure, a third clamp tool (not shown) is provided and extends into the second mounting recess 1210 to support the second cable 52; and a fourth clamp tool (not shown) is provided and inserted into the second through hole 1217 along the second direction A2-A2 to abut against the second tail portion 323 of the second conductive terminal 32. At this time, the second tail portion 323 of the second conductive terminal 32 and the second core 521 of the second cable 52 are clamped between the third clamp tool and the fourth clamp tool. Therefore, the contact reliability between the second tail portion 323 of the second conductive terminal 32 and the second core 521 of the second cable 52 is improved, and the soldering or welding yield can be improved.

After the soldering or welding process is completed, the first clamp tool, the second clamp tool, the third clamp tool and the fourth clamp tool are removed.

Then, the first shielding plate 61 and the first shielding cover 62 are installed on the first conductive housing 11; and the second shielding plate 63 and the second shielding cover 64 are installed on the second conductive housing 12. The first shielding plate 61 replaces the first clamp tool and fills the position of the first clamp tool during the soldering or welding process of the first cable 51 and the first conductive terminal 31, which avoids the impact of losing supporting to the first cable 51 due to removal of the first clamp tool. The first shielding cover 62 is received in the first receiving recess 1114 to cover the first through holes 1117, thereby improving the shielding effect.

Similarly, the second shielding plate 63 replaces the third clamp tool and fills the position of the third clamp tool during the soldering or welding process of the second cable 52 and the second conductive terminal 32, which avoids the impact of losing supporting to the second cable 52 due to removal of the third clamp tool. The second shielding cover 64 is received in the second receiving recess 1214 to cover the second through holes 1217, thereby improving the shielding effect.

Then, the first ground sheet 41 and the second ground sheet 42 are installed on the first conductive housing 11 and the second conductive housing 12, respectively.

Then, the first conductive housing 11 and the second conductive housing 12 are attached to each other. The first base portion 111 and the second base portion 121 correspond along the top-bottom direction. The first protruding portion 112 and the second protruding portion 122 correspond along the top-bottom direction. The first shielding plate 61 and the second shielding plate 63 are in contact with each other to share a grounding area and improve the grounding shielding effect. In the second direction A2-A2, the first shielding plate 61 and the second shielding plate 63 are located between the plurality of first conductive terminals 31 and the plurality of second conductive terminals 32 to reduce crosstalk between the first conductive terminals 31 and the second conductive terminals 32. Besides, in order to further increase the bonding force of the first conductive housing 11 and the second conductive housing 12, the first conductive housing 11 and the second conductive housing 12 are soldered or welded at the joining position. For example, as shown in FIG. 9, the first conductive housing 11 defines an upwardly recessed first welding groove 11a at the joining position, and the second conductive housing 12 defines a downwardly recessed second welding groove 12a at the joining position. The first welding groove 11a and the second welding groove 12a at corresponding positions are in communication, thereby facilitating filling of solder in the first welding groove 11a and the second welding groove 12a. As a result, the first conductive housing 11 and the second conductive housing 12 are fixed by soldering welding. When the first conductive housing 11 and the second conductive housing 12 are fixed, the receiving slot 101 for receiving the mating module 300 is formed between the first protruding portion 112 and the second protruding portion 122.

It is understandable to those skilled in the art that the order of the steps in the above assembly method can be flexibly adjusted as needed, and will not be described again in the present disclosure.

Compared with the prior art, the first tail portion 313 of the first conductive terminal 31 is electrically connected to the first cable 51, and the second tail portion 323 of the second conductive terminal 32 is electrically connected to the second cable 52, which facilitates high-speed signal transmission through the first cable 51 and the second cable 52, thereby being suitable for meeting high-speed signal transmission requirements. Besides, the electrical connector 100 of the present disclosure is provided with the first conductive housing 11 and the second conductive housing 12. The first conductive terminals 31 are not in contact with the first conductive housing 11. The second conductive terminals 32 are not in contact with the second conductive housing 12. The first conductive housing 11 of the first module M1 and the second conductive housing 12 of the second module M2 are separately arranged and fixed together to jointly form the receiving slot 101. With this arrangement, the present disclosure improves the shielding effect on the first conductive terminals 31 and the second conductive terminals 32, and improves the quality of signal transmission.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a first module comprising:
a first conductive housing;
a first terminal module, the first terminal module being at least partially mounted to the first conductive housing; the first terminal module comprising a plurality of first conductive terminals; each first conductive terminal comprising a first contact arm and a first tail portion; the first contact arm comprising a first contact portion configured to be in contact with a mating module to achieve electrical connection; and
a plurality of first cables, the plurality of first cables being electrically connected to the first tail portions of the first conductive terminals of the first terminal module;
a second module comprising:
a second conductive housing;
a second terminal module, the second terminal module being at least partially mounted to the second conductive housing; the second terminal module comprising a plurality of second conductive terminals; each second conductive terminal comprising a second contact arm and a second tail portion; the second contact arm comprising a second contact portion configured to be in contact with the mating module to achieve electrical connection; and
a plurality of second cables, the plurality of second cables being electrically connected to the second tail portions of the second conductive terminals of the second terminal module;
wherein the first conductive housing of the first module and the second conductive housing of the second module are separately arranged and fixed together to jointly form a receiving slot; the receiving slot is configured to at least partially receive the mating module along a first direction; the first contact portions of the first conductive terminals and the second contact portions of the second conductive terminals protrude into the receiving slot;
the first module and the second module are a same module with different installation angles.

2. The electrical connector according to claim 1, wherein the first conductive housing defines at least one first terminal module installation slot in which the first terminal module is installed; and
wherein the second conductive housing defines at least one second terminal module installation slot in which the second terminal module is installed.

3. The electrical connector according to claim 1, wherein the first module comprises a first shielding plate installed on the first conductive housing;
the second module comprises a second shielding plate installed on the second conductive housing;
wherein the first shielding plate and the second shielding plate are in contact with each other; the first shielding plate and the second shielding plate are located between the plurality of first conductive terminals and the plurality of second conductive terminals along a second direction; and the second direction is perpendicular to the first direction.

4. The electrical connector according to claim 2, wherein the first module comprises a first shielding plate installed on the first conductive housing; the first shielding plate comprises a plurality of first protrusions abutting against corresponding first cables;
the second module comprises a second shielding plate installed on the second conductive housing; the second shielding plate comprises a plurality of second protrusions abutting against corresponding second cables.

5. The electrical connector according to claim 4, wherein the first conductive housing defines a first mounting recess communicating with the first terminal module installation slot;
the first shielding plate is a metal shielding plate; the first shielding plate comprises a first main body portion installed in the first mounting recess; the first protrusions are integrally stamped from the first main body portion; the first protrusions abut against the corresponding first cables;
the second conductive housing defines a second mounting recess communicating with the second terminal module installation slot;
the second shielding plate is a metal shielding plate; the second shielding plate comprises a second main body portion installed in the second mounting recess; the second protrusions are integrally stamped from the second main body portion; the second protrusions abut against the corresponding second cables.

6. The electrical connector according to claim 5, wherein the first main body portion and the second main body portion are abutted together along a second direction; the second direction is perpendicular to the first direction; the first protruding portion and the second protruding portion protrude along the second direction but protrude in opposite directions.

7. The electrical connector according to claim 1, wherein each first cable comprises a first core; the first core is located at a bottom of the first tail portion of the first conductive terminal and is fixed to the first tail portion by soldering or welding;
the second cable comprises a second core; the second core is located on a top of the second tail portion of the second conductive terminal and is fixed to the second tail portion by soldering or welding.

8. The electrical connector according to claim 1, wherein at a position where the first conductive housing and the second conductive housing are engaged, the first conductive housing defines a first welding groove, the second conductive housing defines a second welding groove communicating with the first welding groove.

9. The electrical connector according to claim 1, wherein the first conductive housing is a metal housing or a composite housing formed by electroplating a metal material on an insulating material;
the second conductive housing is a metal housing or a composite housing formed by electroplating a metal material on an insulating material.

10. The electrical connector according to claim 2, wherein each first conductive terminal comprises a first fixing portion connected between the first contact arm and the first tail portion;
the first terminal module comprises two first conductive terminals which are a first signal terminal and a second signal terminal, respectively; the first terminal module further comprises a first holding block fixed on the first fixing portion of the first signal terminal and the first fixing portion of the second signal terminal; the first holding block is secured in the first terminal module installation slot; neither the first signal terminal nor the second signal terminal is in contact with the first conductive housing;
each second conductive terminal comprises a second fixing portion connected between the second contact arm and the second tail portion;
the second terminal module comprises two second conductive terminals which are a third signal terminal and a fourth signal terminal, respectively; the second terminal module further comprises a second holding block fixed on the second fixing portion of the third signal terminal and the second fixing portion of the fourth signal terminal; the second holding block is secured in the second terminal module installation slot; neither the third signal terminal nor the fourth signal terminal is in contact with the second conductive housing.

11. The electrical connector according to claim 10, wherein the first conductive housing comprises a first front end surface and a first filling groove extending forwardly through the first front end surface along the first direction;
the second conductive housing comprises a second front end surface and a second filling groove extending forwardly through the second front end surface along the first direction;
the first module comprises a first insulating fixing block molded in the first filling groove;
the first insulating fixing block defines a first slit and a second slit; an end of the first contact arm of the first signal terminal extends at least partially into the first slit; an end of the first contact arm of the second signal terminal extends at least partially into the second slit;
the second module comprises a second insulating fixing block molded in the second filling groove; the second insulating fixing block defines a third slit and a fourth slit; an end of the second contact arm of the third signal terminal extends at least partially into the third slit; an end of the second contact arm of the fourth signal terminal extends at least partially into the fourth slit.

12. The electrical connector according to claim 1, wherein the first module comprises a first ground sheet mounted to the first conductive housing; one end of the first ground sheet is fixed relative to the first conductive housing; the first ground sheet comprises a first grounding elastic arm at least partially protruding into the receiving slot; one end of the first grounding elastic arm is fixed, and another end of the first grounding elastic arm is movable along the first direction when the mating module is inserted into the receiving slot;
the second module comprises a second ground sheet mounted to the second conductive housing; one end of the second ground sheet is fixed relative to the second conductive housing;
the second ground sheet comprises a second grounding elastic arm at least partially protruding into the receiving slot; one end of the second grounding elastic arm is fixed, and another end of the second grounding elastic arm is movable along the first direction when the mating module is inserted into the receiving slot.

13. The electrical connector according to claim 1, wherein the first module comprises a first shielding cover mounted on the first conductive housing; the second module comprises a second shielding cover installed on the second conductive housing;
the electrical connector comprises a first ground cable and a second ground cable; the first ground cable is in contact with the first shielding cover; the second ground cable is in contact with the second shielding cover.

14. An electrical connector, comprising:
a first module comprising:
a first conductive housing;
a plurality of first terminal modules, the first terminal modules being at least partially mounted to the first conductive housing; each first terminal module comprising a plurality of first conductive terminals; each first conductive terminal comprising a first contact arm;
the first contact arm comprising a first contact portion configured to be electrically connected with a mating module; and
a plurality of first cables, the plurality of first cables being electrically connected to the first conductive terminals of the first terminal modules;
a second module comprising:
a second conductive housing;
a plurality of second terminal modules, the second terminal modules being at least partially mounted to the second conductive housing; each second terminal module comprising a plurality of second conductive terminals; each second conductive terminal comprising a second contact arm; the second contact arm comprising a second contact portion configured to be electrically connected with the mating module; and
a plurality of second cables, the plurality of second cables being electrically connected to the second conductive terminals of the second terminal modules;
wherein the first conductive housing of the first module and the second conductive housing of the second module are separately arranged and fixed together to jointly form a receiving slot; the receiving slot is configured to at least partially receive the mating module along a first direction;
the first module and the second module are shared modules with different installation angles.

15. The electrical connector according to claim 14, wherein the first conductive housing defines a plurality of first terminal module installation slots in which the plurality of first terminal modules are installed; and
wherein the second conductive housing defines a plurality of second terminal module installation slots in which the plurality of second terminal modules are installed.

16. The electrical connector according to claim 14, wherein the first module comprises a first shielding plate installed on the first conductive housing;
the second module comprises a second shielding plate installed on the second conductive housing;
wherein the first shielding plate and the second shielding plate are in contact with each other; the first shielding plate and the second shielding plate are located between the plurality of first conductive terminals and the plurality of second conductive terminals along a second direction; and the second direction is perpendicular to the first direction.

17. The electrical connector according to claim 15, wherein the first module comprises a first shielding plate installed on the first conductive housing; the first shielding plate comprises a plurality of first protrusions abutting against corresponding first cables;
the second module comprises a second shielding plate installed on the second conductive housing; the second shielding plate comprises a plurality of second protrusions abutting against corresponding second cables.

18. The electrical connector according to claim 17, wherein the first conductive housing defines a first mounting recess communicating with the first terminal module installation slot;
the first shielding plate is a metal shielding plate; the first shielding plate comprises a first main body portion installed in the first mounting recess; the first protrusions are integrally stamped from the first main body portion; the first protrusions abut against the corresponding first cables;
the second conductive housing defines a second mounting recess communicating with the second terminal module installation slot;
the second shielding plate is a metal shielding plate; the second shielding plate comprises a second main body portion installed in the second mounting recess; the second protrusions are integrally stamped from the second main body portion; the second protrusions abut against the corresponding second cables;
the first main body portion and the second main body portion are abutted together along a second direction; the second direction is perpendicular to the first direction; the first protruding portion and the second protruding portion protrude along the second direction but protrude in opposite directions.

19. The electrical connector according to claim 14, wherein at a position where the first conductive housing and the second conductive housing are engaged, the first conductive housing defines a first welding groove, the second conductive housing defines a second welding groove communicating with the first welding groove.

20. The electrical connector according to claim 14, wherein the first module comprises a first shielding cover mounted on the first conductive housing; the second module comprises a second shielding cover installed on the second conductive housing;
the electrical connector comprises a first ground cable and a second ground cable; the first ground cable is in contact with the first shielding cover; the second ground cable is in contact with the second shielding cover.
